(19) United States
(12) Patent Application Publication
(10) Pub. No.: US 2005/0025894 A1
(43) Pub. Date: Feb. 3, 2005

(54) Method of improving the wear resistance performance of mechanical component

(76) Inventors: Luquan Ren, Changchun (CN); Hong Zhou, Changchun (CN); Xiaoming Qiu, Changchun (CN); Qingping Liu, Changchun (CN); Zhanrong Cui, Changchun (CN); Zhiwu Han, Changchun (CN); Guilan Zhang, Changchun (CN); Jianqiao Li, Changchun (CN); Jin Tong, Changchun (CN); Yanchun Qian, Changchun (CN); Yuguang Zhao, Changchun (CN)

Correspondence Address: Karl F. Milde, Jr., Esq.;MILDE & HOFFBERG, L.L.P., Suite 460, 10 Bank Street, White Plains, NY, 10606, US

(21) Appl. No.: 10/878,887

(22) Filed: Jun. 28, 2004

(30) Foreign Application Priority Data
Jul. 29, 2003 (CN) 03127650.4

(51) Int. Cl. C23C 8/50; B23K 26/00

(52) U.S. Cl. 427/421.1; 219/121.6

(57) ABSTRACT

The invention relates to the design and manufacturing technique of mechanical component which is prone to be worn in relative movement. More particularly, it relates to a method of improving the wear resistance performance of the surface of mechanical component. In this method, a bionic non-smooth morphology is formed on the frictional surface of the mechanical component. That is, a plurality of convex units shaped as crown, dimple, scale, mesh, stripe and so on are distributed on the surface. These units are 0.01-2 mm higher than the base surface. The distributed density (S) of the units, i.e., the ratio of the geometrical area of the convex units projected on the surface of the base with respect to the whole surface area of the base, is 10-40%. The hardness difference between the units and the base is HB0-200. It breaks through the conventional concept and provides a more rational and effective way to improve the wear resistance performance of mechanical component.

### FIELD OF THE INVENTION

This invention relates to the design and manufacture of mechanical component (or machinery part) which is prone to be worn during relative movement. More particularly, the invention relates to a method of improving the wear resistance performance of the surface of mechanical component.

### DECRIPTION OF THE PRIOR ART

The wear brought by the relative movement such as sliding, rotation, rolling of the mechanical components is one of the main reasons for the invalidation thereof. Besides other methods used in and out abroad such as finding new wear-proof materials, adding some lubricant or making a more rational design on structure, surface hardening is an important way to improve the quality of mechanical components and prolong the longevity of service as well as meliorate the functional performance thereof. At present, chemical treatment, laser treatment, heat treatment by electron beam, bead welding, spraying, depositing, plating etc. are the common techniques of surface hardening. Most of these methods deal with the whole surface of the chemical component to be used, which have the disadvantages of long disposal time and a thin hardening layer which can be easily worn in the service and result in the lost of protection to the mechanical components. Moreover, they also decrease the validity of the mechanical components in various working conditions. Furthermore, it is limited to increase the surface rigid of materials. Meanwhile, we are used to improving the smooth of the surface of the mechanical component as a necessary means to improve the abrasion performance thereof in conventional concept.

### SUMMARY OF THE INVENTION

In order to overcome the above drawback in the prior art, the object of the invention is to bring forward a more rational and effective method of improving the wear resistance performance of the mechanical component, which breaks through the conventional concept and has the advantages of being implemented by simple technique, reliable performance and low cost.

According to the conventional concept, the smoother the surface of an object is, the lower the adhesive force between the object and other things will be. Therefore, the working components or products that need to decrease the friction or adhesion were designed with smooth surface(s). However, the nature shows us another side of this issue that the surfaces or plumages of the flying creatures are not evolved into smooth surfaces, but non-smooth surfaces with low energy composed of feathers. At the same time, the swimming creatures, especially the prompt ones such as shark which has a terrific speed of 10-20 m/s when it starts up, have not smooth surfaces, but non-smooth surfaces composed of scale or connective tissue. The water tunnel experiment validated that the properly designed non-smooth surface has lower resistance than smooth surface.

The non-smooth morphology is a new bionic idea brought forward by researching on the structure and friction of various body materials of creatures. According to the research on some creatures such as dung beetle, shellfish, pangolin, snake, lizard, bamboo, the adhesion reducing and wear resistance performance of the creatures' surface are closely related to their non-smooth morphology. The non-smooth morphology of the surface makes contribution to reducing the sticking friction and friction factor, and it converts the scrape and chiseling existing in friction into rolling, which reduces the damage to its surface. This characteristics, which adapts to environment, are formed gradually in the evolution of tens of thousands years. Different creatures have different non-smooth morphologies depended on the different surviving surroundings, the examples of which including: the convex crowns (FIG. 1, the head of dung beetle), the concave hollows (FIG. 2, the head of ant), the ridges or corrugations (FIG. 3, the elytrum of necriphorus japonicus), the scales (FIG. 4, the pangolin and the fish), the grids (the leg of locust), the texture (FIG. 5, the abdomen of the dung beetle) and stripe and so on. The size of different non-smooth units of different creatures varies from microns to millimeters. For instance, the diameter of convex crowns on the dung beetle's head is about 12-16 micron, the height of crowns is about 6-8 microns; the length of the longer axis of the scale on the surface of the pangolin is 20-40 millimeter, the length of the shorter axis thereof is 10-20 millimeter in, and the height thereof is 1-4 millimeter. By the analysis of the non-smooth surface and a plenty of experiments, it shows that the wear resistance performance of the surfaces of mechanical components in relative movement (such as sliding block, drill stem, bearing tile, steel roller) would be obviously increased when we put the good wear resistance performance of non-smooth morphology into various surfaces of these mechanical components, and the friction coefficient, the friction as well as the adhesive force would be greatly lowered.

Based on the above result of research, the invention brings forward a new method of improving the wear resistance performance of the mechanical component in relative movement. Briefly, this new method adopts machining and all kinds of surface treatment processes to form non-smooth morphology on the surface(s) of the mechanical component, so as to greatly improve the wear resistance performance of the mechanical component.

Specially, the invention provides a method of improving the wear resistance performance of a mechanical component, comprising: making the frictional surface of the mechanical component be a bionic non-smooth surface (in other words, according to the working validity of different mechanical components in various working conditions, the frictional surface of the mechanical component is machined into bionic non-smooth morphology), wherein a plurality of convex units are distributed on the surface of the base of the mechanical component, the altitude difference between the convex units and the base is 0.01-2 mm, the distributed density (S) of the units, i.e., the ratio of the geometrical area of the convex units projected on the surface of the base with respect to the whole surface area of the base, is 10-40%,. and the hardness difference between the units and the base is HB0-200 (or HRC0-30).

According to the actual working conditions, the non-smooth morphology could be composed of spherical crowns, ridges, scales, grids, textures or stripes. In other words, the convex units may be shaped as crown, scale, mesh or stripe, etc. The ridge and grid can be regarded as stripe-shaped non-smooth convex units constituted by a plurality of convex crowns or scales. The ridge can be formed when these non-smooth units are arrayed in parallel and the grid can be formed when these non-smooth units are arrayed in across. The distributing rule of the convex units and the hardness difference of the base and the units as well as the size of the units play an important role in improving the wear resistance performance of the mechanical components in relative movement. Rational design of the non-smooth morphologies would remarkably improve the wear resistance performance of the mechanical components in relative movement evidently.

The hardness difference of the convex units and the base is determined by the dynamics conditions of friction couples and the material used. According to the friction couples existing in the mechanical components in relative movements and the metal materials used, the hardness difference may vary from HB0-200 (or HRC 0-30). The hardness difference can guarantee the evident increase of wear resistance performance of any mechanical component in relative movement. Meanwhile, the size of the convex units is determined by the height difference and the area ratio of the convex units with respect to the surface of the base.

In accordance with a further feature of the invention, the spherical crown-like convex units are distributed as a matrix in the following mode: the diameter of the base circle of the crown is 1-3 mm, the height of the crown is 0.1 mm, and the distributed density (S) of the convex units is 12-18%.

In accordance with a further feature of the invention, the spherical crown-like convex units are distributed as diamond or rhombus in the following mode: the diameter of the base circle of the crown is 10-30 mm, the height of the crown is 2 mm.

In accordance with a further feature of the invention, the mesh-like convex units are distributed as square in the following mode: the width of the mesh is 1.5-2 mm, the distance between adjacent meshes is 6-10 mm, and the height of the mesh is 0.01-0.15 mm.

In accordance with a further feature of the invention, the mesh-like convex units are distributed as diamond in the following mode: the width of the mesh is 1.5-2.0 mm, the distance between adjacent meshes is 6-10 mm, the smaller angle between the adjacent meshes is 400, and the height of the mesh is 0.01-0.15 mm.

In accordance with a further feature of the invention, the stripe-like convex units are distributed in the following mode: the width of the stripe is 1-3 mm, the distance between the adjacent stripes is 6-10 mm, and the height of the stripe is 0.01-2.0 mm.

In accordance with a further feature of the invention, the scale-like convex units are distributed in the following mode: the length of the longer axis of the scale is 20-40 mm, the length of the shorter axis of the scale is 10-20 mm, the height of the scale is 0.5-2.0 mm.

In terms of this inventive method, the manufacturing process of the wear resistance performance mechanical components with the non-smooth morphology can be carried out as follows: Firstly, according to the theory of bionics, the surface of mechanical components with bionic non-smooth morphologies is designed based on the computer simulation. Then, the bionic non-smooth units on the surface of the mechanical components in relative movement are machined by means of laser, spraying, combination of machining and surface treatment or any other suitable process for this purpose well known in the art. Thus, the desired wear resistance performance of the mechanical components with bionic non-smooth morphology can be obtained.

The longevity of wear resistance performance of the mechanical component with non-smooth morphology is 1-8 times longer than that with the smooth surface. 0 n the other hand, the cost of manufacturing process is only increased about 10-80%. Therefore, this method has a high ratio of performance/cost.

In this invention, the bionic non-smooth technology is used so as to machine the surface of the mechanical component in relative movement into a bionic non-smooth surface with patterns having various morphology, size and distributed rule. Consequently, it has the advantages of simple in manufacturing, reliable performance, low cost and high wear resistance performance.

The above and other objects, features and advantages of the invention will become apparent from the following description of the preferred embodiments, taken in conjunction with the accompanying drawings.

### BRIEF DESCRIPTION OF THE DRAWINGS

FIG. 1 is the microstructure photograph of a head of dung beetle.

FIG. 2 is the microstructure photograph of a head of ants.

FIG. 3 is the microstructure photograph of the elytrum of a necriphorus japonicus.

FIG. 4 is the microstructure photograph of body surface of a pangolin and the fish.

FIG. 5 is the microstructure photograph of the abdomen of a dung beetle.

FIG. 6A, 6B show a bionic non-smooth morphology w ith scale-like units and its effect on the wear resistance performance.

FIG. 7A, 7B show a bionic n on-smooth morphology with crown or bulge-like convex units and its effect on the wear resistance performance.

FIG. 8A, 8B show a bionic non-smooth morphology with diamond-like convex units and its effect on the wear resistance performance.

FIG. 9A, 9B show a bionic non-smooth morphology with stripe-like convex units and its effect on the wear resistance performance.

FIG. 10 is a schematic view of spherical crown-like convex units according to one embodiment of the invention.

FIG. 11 is a schematic view of mesh-like convex units according to one embodiment of the invention.

FIG. 12 is a schematic view of mesh-like convex units according to another embodiment of the invention.

FIG. 13 is a schematic view of stripe-like convex units according to one embodiment of the invention.

FIG. 14 is a schematic view of scale-like convex units according to one embodiment of the invention.

FIG. 15 is a schematic view of spherical crown-like convex units according to another embodiment of the invention.

FIG. 16 shows the working principle scheme of a formed punch as one kind of application of the invention.

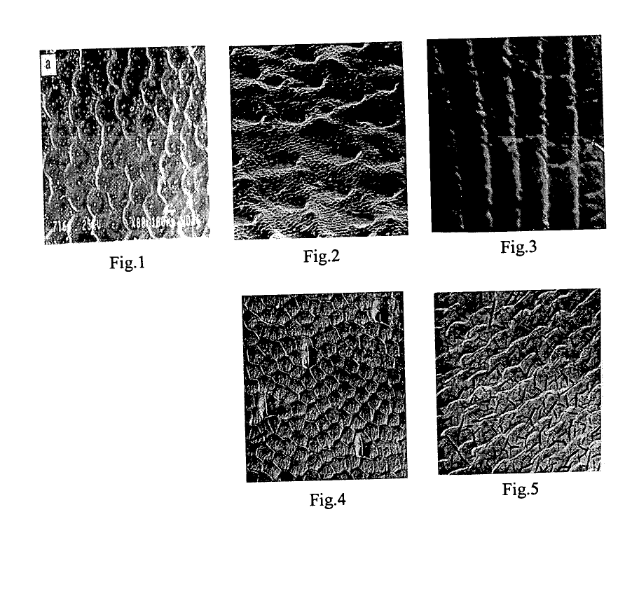

### DESCRIPTION OF THE PREFERRED EMBODIMENTS

According to the engineering bionics research results and the computer simulation, the bionic non-smooth surface morphology pattern of mechanical components in relative movement with high wear resistance performance can be properly designed. For example, by the process of laser treatment, the mechanical components in relative movement can be machined into the patterns with bionic non-smooth surface morphology. Consequently, the principle of the influence of bionic non-smooth surface morphology pattern on the wear resistance performance can be obtained.

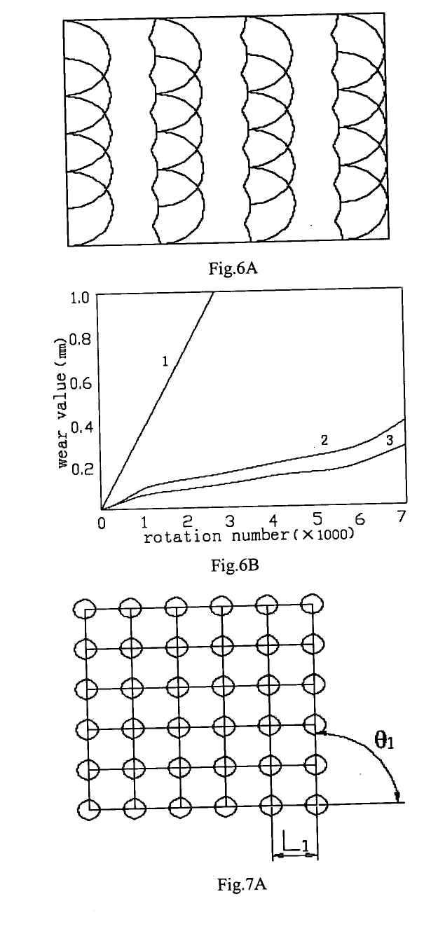

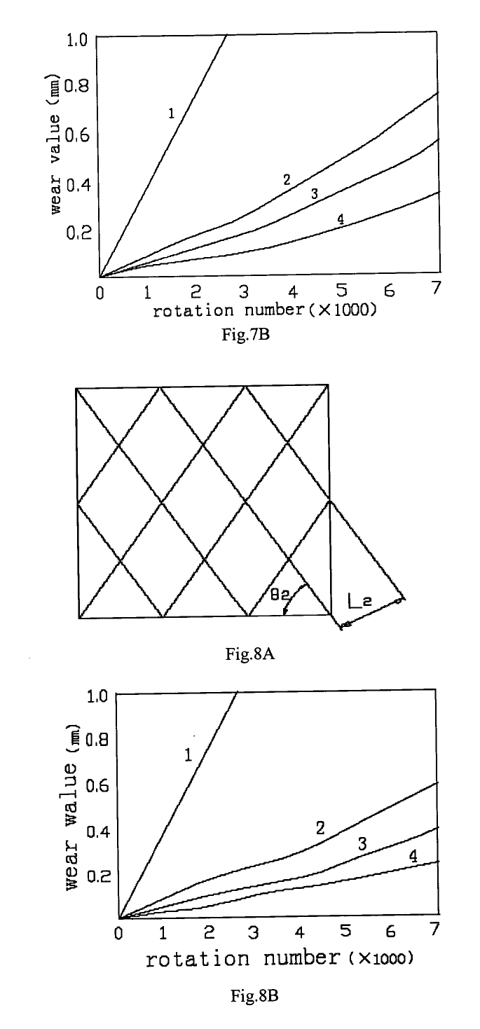

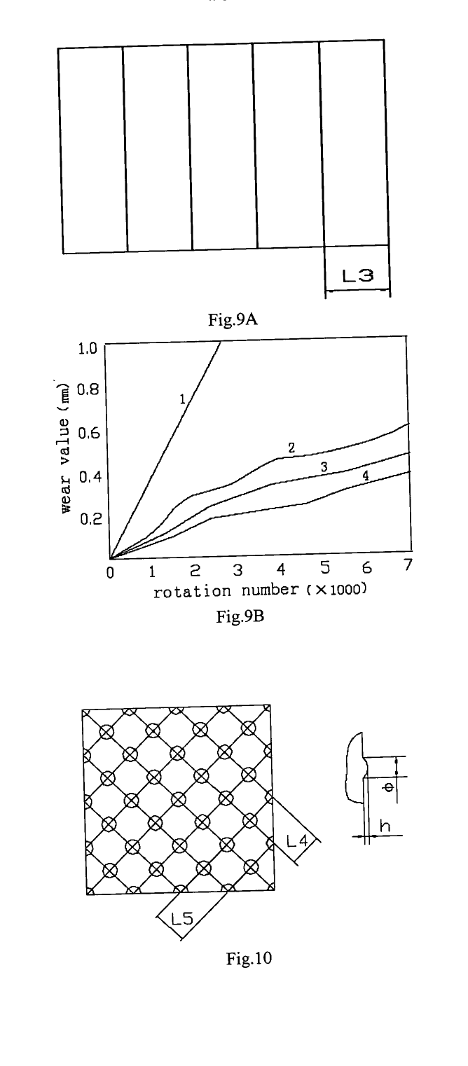

FIG. 6, FIG. 7, FIG. 8 and FIG. 9 show the research results of the influence of various bionic non-smooth surface morphology patterns on wear resistance performance, respectively. Among those, the friction couples are composed by the mechanical components in relative movement and the metal materials used are gray cast iron, the distributed density (S) of convex units in the bionic non-smooth surface morphology formed on the mechanical component (i.e., the base to be treated) is 20-40%, which is the ratio of the whole geometrical area of the convex units projected on the surface of the base with respect to the surface area of the base, and the hardness difference between the convex units and the base is HB100.

In details, FIG. 6A, 6B shows the bionic non-smooth surface morphology with scale-like convex units and its effect on the wear resistance performance. In FIG. 6B, curve 1 represents a smooth surface, curve 2 represents a non-smooth surface with scale-like convex units having a longer axis of 40 mm, a shorter axis of 20 mm and a height of 3 mm, curve 3 represents a non-smooth surface with scale-like convex units having a longer axis of 20 mm, a shorter axis of 10 mm and a height of 2 mm.

FIG. 7A, 7B show the bionic non-smooth surface morphology with spherical crown-like convex units (the diameter of the base circle is 3 mm) and its effect on the wear resistance performance. In FIG. 7B, curve 1 represents a smooth surface, curve 2 represents a non-smooth surface with θ₁=90°, L₁=8 mm, curve 3 represents a non-smooth surface with θ₁=80═, L₁=10 mm, the reference number 4 represents a non-smooth surface with θ₁=85°, L₁=6 mm.

FIG. 8A, 8B show the bionic non-smooth surface morphology with diamond-like convex units (the mesh width of the diamond is 2 mm) and its effect on the wear resistance performance. In FIG. 8B, curve 1 represents a smooth surface, curve 2 represents a non-smooth surface with θ₂=90°, L₂=10 mm, curve 3 represents a non-smooth surface with θ₂=80°, L₂=6 mm, the reference number 4 represents a non-smooth surface with θ₂=65°, L₂=8 mm.

FIG. 9A, 9B show the bionic non-smooth surface morphology with stripe-like convex units (the width of the stripe is 2 mm) and its effect on the wear resistance performance. In FIG. 9B, curve 1 represents a smooth surface, curve 2 represents a non-smooth surface with L₃=40 mm, curve 3 represents a non-smooth surface with L₃₌₈ mm, curve 4 represents a non-smooth surface with L₃=6 mm.

It can be seen from the result of the experiments, by forming the surface of a mechanical component as a bionic non-smooth surface in suitable way, the wear resistance performance of the mechanical component can be improved from 1 to 8 times compared with the smooth surface as that in the prior art.

The principle, features and advantages of the invention will be best understood more in details from the following description of specific, exemplified embodiments on various applications.

1. The Application of the Invention on One Component of the Die-Casting Machine-the Formed Punch

As an example of the first application of the method of this invention, it can be used to produce the formed punch-one common component of the Die-casting machine. FIG. 16 shows the working principle of the formed punch. When the machine works, alloy liquid 40 is injected from an injection gate 50 to a chamber 30. The formed punch 60 driven by a hydraulic cylinder 70 quickly presses the alloy liquid 40 into a mold. At the same time, in order to force the casting part 10 formed in the mold by the pressure, hydraulic cylinder 70 continues to press the formed punch 60. A sliding contact is formed between the formed punch 60 and the wall (i.e., the coupling cylinder jacket) of the chamber 30. The pressure on the formed punch exerted by the hydraulic cylinder 70 is 5-7 MPa. The alloy liquid is injected into the mold under a high pressure and also injected into the clearance between the formed punch 60 and the chamber 30. The alloy liquid 40 that is injected into the clearance becomes solid later. Since the formed punch 60 and the wall of the chamber 30 form a friction couple and the hardness of the inner wall of the chamber 30 is greater than that of the formed punch 60, the formed punch 60 is worn by the alloy solid when the relative motion between the formed punch 60 and the plunger tip 30 begin. With the clearance between the formed punch 60 and the wall of the chamber 30 increasing, the alloy liquid 40 will flow through the clearance, and the pressure of the alloy liquid 40 will decrease. As a result, the formed punch 60 will be replaced by a new one. The material of the formed punch 60 is ductile iron. The formed punch 60 is machined from a cylinder rough cast from ductile iron. The price of a formed punch with the diameter of 50 mm is about RMB56. The average service life is 8 hours. The bionic non-smooth surface of the formed punch is formed on the base of a smooth surface through computer simulation and wearability experiments and by laser treatment. The different kinds of design and the technical effect of the non-smooth surface on the punch are given by Example 1 to 10.

### EXAMPLE 1

A formed punch of die-casting machine with spherical crown-like convex units on its surface is manufactured. Referring to FIG. 10, the diameter φ of the base circle of the convex units is 1-3 mm, the height h of the convex unit is 0.1 mm, the convex units are distributed as a matrix with a space (or interval) of 6-9 mm between adjacent convex units, for instance, L₄=6 mm, L₅=9 mm. The distributed density of the convex units, i.e., the ratio of the geometrical area of the convex units projected on the surface of the base with respect to the whole surface area of the base, is 12-18%. An angle of 45° is formed between the sideline of the matrix and the axes line of the punch. The material used is QT600-2. The hardness of the base (i.e., the punch) is HB190-210, and the hardness of the spherical crown-like convex units is HB380-410. The surface of coupling cylinder jacket is treated by surface nitriding process, and its hardness is HB470-500. As a result, under the same working condition, when compared to the punch with smooth surface, the longevity of the coupling cylinder jacket remains the same, the friction coefficient between the punch with the bionic non-smooth surface morphology as mentioned above and the coupling cylinder jacket is reduced by 17%, and the service life of the bionic non-smooth punch is four times longer than the smooth one.

### EXAMPLE 2

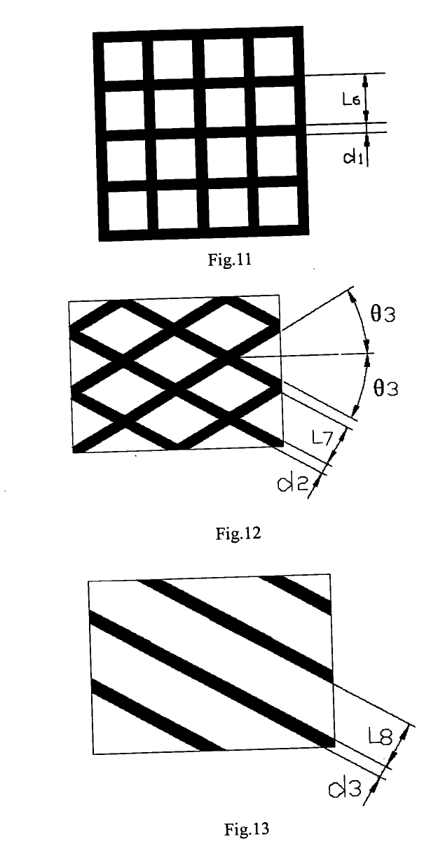

A formed punch of die-casting machine with mesh-like convex units on its surface is manufactured. The mesh-like convex unit can also be viewed as stripe unit composed by some continual spherical crowns, and the directions of these stripes can be parallel or crossed. If these stripes are parallel, a ridge-like surface morphology is formed; if these stripes are crossed, a grid-like surface morphology is formed. According to this idea, the mesh-like convex units can be viewed as a plurality of continual spherical crown or bulge shaped convex u nits, which will simplify the process of machining and laser treatment. Referring to FIG. 11, in this example, the width d₁ of the mesh is 1.6-2 mm. The ratio of the geometrical area of the mesh units projected on the surface of the base with respect to the whole surface area of the base is 12-17%. The height of the mesh is 0.15 mm. The mesh units are arrayed as a square, the distance L₆ between adjacent mesh units (center to center) is 10 mm. The material used is QT600-2. The hardness of the base is HB190-210, and the hardness of the machined mesh units is HB390-410. The surface of coupling cylinder jacket is treated with nitriding technique, and its hardness is HB470-500. As a result, under the same working condition, when compared to the punch with smooth surface, the longevity of the coupling cylinder jacket remains the same, the friction coefficient between the punch with the bionic non-smooth surface morphology as mentioned above and the coupling cylinder jacket is reduced by 15%, and the service life of the bionic non-smooth punch is 4.6 times longer than the smooth one.

### EXAMPLE 3

A formed punch of die-casting machine with mesh-like convex units on its surface is manufactured. Referring to FIG. 11, the mesh-like convex units are distributed as a square. The width d₁ of the mesh is 1.6-2 mm, the distance L₆ between adjacent meshes (center to center) is 6 mm, and the height of the mesh is 0.01 mm. The ratio of the geometrical area of the mesh units projected on the surface of the base with respect to the whole surface area of the base is 23-25%. The material used is QT600-2. The hardness of the part is HB190-210, and the hardness of the machined mesh units is HB390-410. The surface of coupling cylinder jacket is treated by surface nitriding process, and its hardness is HB470-500. As a result, under the same working condition, when compared to the punch with smooth surface, the longevity of the coupling cylinder jacket remains the same, the friction coefficient between the punch with the bionic non-smooth surface morphology as mentioned above and the coupling cylinder jacket is reduced by 20%, and the service life of the bionic non-smooth punch is 5.7 times longer than the smooth one.

### EXAMPLE 4

A formed punch of die-casting machine with mesh-like convex units on its surface is manufactured, so that a non-smooth surface is formed.

Referring to FIG. 11, the mesh unit has a width d₁ of 1.8-2.0 mm and a height of 0.1 mm. The mesh units are arranged in square shape and the distance L₆ between adjacent mesh units (center to center) is 8 mm. The ratio of the geometrical area of the mesh units projected on the surface of the base with respect to the whole surface area of the base is 10%. The material used is QT600-2. The hardness of the base is HB190-210. After treated, the hardness of the mesh units is HB190-210. The coupling cylinder jacket is treated by surface nitride hardening to have a hardness of HB470-500. As a result, under the same working condition, when compared to the punch with smooth surface, the longevity of the coupling cylinder jacket remains the same, the friction coefficient between the punch with the bionic non-smooth surface morphology as mentioned above and the coupling cylinder jacket is reduced by 23.2%, and the service life of the bionic non-smooth punch is 6.3 times longer than the smooth one.

### EXAMPLE 5

A formed punch of die-casting machine with another kind of mesh-like (diamond shape) convex units on its surface is manufactured. The convex units in this configuration of the non-smooth surface can also be regarded as stripe convex units composed of sequential multi-spherical crowns (or sphere coronals), and the direction of these stripes may be parallel or crossed each other. When these stripes are parallel, a ripple shape is formed; when these stripes are crossed, a grid shape is formed. The configuration of the non-smooth surface can be designed to a diamond shape wherein the stripes are crossed each other. Referring to FIG. 12, in this example, the stripe unit presents an angle θ₃ of 45° with respect to the axis direction having a width d₂ of 1.8-2.0 mm and a height of 0.15 mm, and the distance L₇ between adjacent units (center to center) is 6 mm. The ratio of the geometrical area of the convex units projected on the surface of the base with respect to the whole surface area of the base is 22.5-25%. The material used is QT600-2. The hardness of the base is HB190-210. After treated, the hardness of the mesh units is HB370-390. The coupling cylinder jacket is treated with by surface nitride hardening to have a hardness of HB450-490. As a result, under the same working condition, when compared to the punch with smooth surface, the longevity of the coupling cylinder jacket remains the same, the friction coefficient between the punch with the bionic non-smooth surface morphology as mentioned above and the coupling cylinder jacket is reduced by 23%, and the service life of the bionic non-smooth punch is 4.7 times longer than the smooth one.

### EXAMPLE 6

A formed punch of die-casting machine with mesh-like (diamond shape) convex units on its surface is manufactured. Referring to FIG. 12, in this example, the stripe in the surface forms an angle θ₃ of 55° with the axis direction having a width d₂ of 1.5-1.8 mm and a height of 0.1 mm, and the distance L₇ between adjacent units (center to center) is 10 mm. The ratio of the geometrical area of the convex units projected on the surface of the base with respect to the whole surface area of the base is 13-15%. The material used is QT600-2. The hardness of the base is HB190-210. After treated, the hardness of the mesh units is HB370-390. The coupling cylinder jacket is treated by surface nitride hardening to have a hardness of HB450-490. As a result, under the same working condition, when compared to the punch with smooth surface, the longevity of the coupling cylinder jacket remains the same, the friction coefficient between the punch with the bionic non-smooth surface morphology as mentioned above and the coupling cylinder jacket is reduced by 15%, and the service life of the bionic non-smooth punch is 3.1 times longer than the smooth one.

### EXAMPLE 7

A formed punch of die-casting machine with mesh-like (diamond shape) convex units on its surface is manufactured. Referring to FIG. 12, in this example, the stripe in the surface forms an angle θ₃ of 65° with respect to the axis direction having a width d₂ of 1.5-1.8 mm and a height of 0.1 mm, and the distance L₇ between adjacent units (center to center) is 8 mm. The ratio of the geometrical area of the convex units projected on the surface of the base with respect to the whole surface area of the base is 15-18%. The material used is QT600-2. The hardness of the base is HB190-210. After treated, the hardness of the mesh units is HB370-390. The coupling cylinder jacket is treated with surface nitride hardening to have a hardness of HB450-490. As a result, under the same working condition, when compared to the punch with smooth surface, the longevity of the coupling cylinder jacket remains the same, the friction coefficient between the punch with the bionic non-smooth surface morphology as mentioned above and the coupling cylinder jacket is reduced by 23%, and the service life of the bionic non-smooth punch is 5.7 times longer than the smooth one.

### EXAMPLE 8

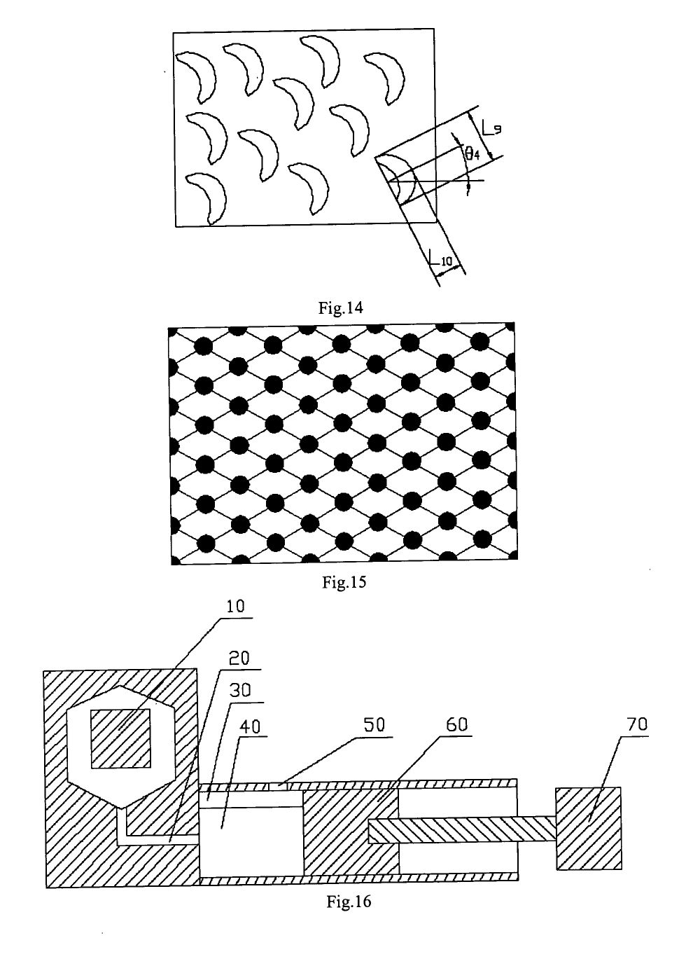

A formed punch of die-casting machine with scale-like convex units on its surface is manufactured. Referring to FIG. 14, the length L₉ of the longer axis of the scale-like convex units is 40 mm, the length L₉ of the shorter axis is 20 mm, and the height of the convex units is 0.5 mm. The distribution of the scale-like convex unit presents a rectangular shape. The sideline of the rectangle and the axis line of the base form an angle θ₄ of 45°. The material used is QT600-2, and the hardness of base is HB190-210. After treated, the hardness of the scale-like convex unit is HB370-390. The coupling cylinder jacket is treated with surface nitride hardening to have a hardness of HB470-500. The ratio of the geometrical area of the convex units projected on the surface of the base with respect to the whole surface area of the base is about 40%. As a result, under the same working condition, when compared to the punch with smooth surface, the longevity of the coupling cylinder jacket remains the same, the friction coefficient between the punch with the bionic non-smooth surface morphology as mentioned above and the coupling cylinder jacket is reduced by 17%, and the service life of the bionic non-smooth punch is 4 times longer than the smooth one.

### EXAMPLE 9

A formed punch of die-casting machine with scale-like convex units on its surface is manufactured. Referring to FIG. 14, the length L₉ of the longer axis of the scale-like convex unit is 20 mm, the length L₁₀ of the shorter axis is 10 mm, and the height is 0.5 mm. The distribution of the scale-like convex unit presents a rectangular shape. The sideline of the rectangle and the axis line of the base form an angle θ₄ of 45°. The material used is QT600-2, and the hardness of the base is HB190-210. After treated, the hardness of the scale-like convex units is HB190-220. The coupling cylinder jacket is treated with surface nitride hardening to have a hardness of HB470-500. The ratio of the geometrical area of the convex units projected on the surface of the base with respect to the whole surface area of the base is about 32.7%. As a result, under the same working condition, when compared to the punch with smooth surface, the longevity of the coupling cylinder jacket remains the same, the friction coefficient between the punch with the bionic non-smooth surface morphology as mentioned above and the coupling cylinder jacket is reduced by 18.8%, and the service life of the bionic non-smooth punch is 4.7 times longer than the smooth one.

### EXAMPLE 10

A formed punch of die-casting machine with scale-like convex units on its surface is manufactured. Referring to FIG. 14, the length L₉ of the longer axis of the scale-like convex unit is 35 mm, the length L₁₀ of the shorter axis is 15 mm, and the height is 0.5 mm. The distribution of the scale-like convex unit presents a rectangular shape. The sideline of the rectangle and axis line of the base form an angle θ₄ of 45. The material used is QT600-2, and the hardness of the base is HB190-210. After treated, the hardness of the scale-like convex unit is HB370-410. The coupling cylinder jacket is treated with surface nitride hardening to have a hardness of HB470-500. The ratio of the geometrical area of the convex units projected on the surface of the base with respect to the whole surface area of the base is about 32.7%. As a result, under the same working condition, when compared to the punch with smooth surface, the longevity of the coupling cylinder jacket remains the same, the friction coefficient between the punch with the bionic non-smooth surface morphology as mentioned above and the coupling cylinder jacket is reduced by 19%, and the service life of the bionic non-smooth punch is 6.1 times longer than the smooth one.

2. The Application of the Invention on a Crank Rotation Part-Crankshaft

The crankshaft is one of important components of an engine, and it can change the reciprocation movement of a piston into a circumferential movement. Under the action of the periodic gas pressure, the inertia force of reciprocation and rotation movement as well as their moments, the crankshaft is bent and rotated. Therefore, the crankshaft must have not only high intensity and rigidity, but also higher wear resistance performance.

Based on the original smooth surface, the crankshaft with bionic non-smooth surface is designed through the computer simulation and wear abrasion test. The surface of the relative motion mechanical component is designed into non-smooth morphology with high wear resistance performance, and manufactured by laser treatment or machining process combined with surface heat-treatment.

### EXAMPLE 11

A crank rotation part-crankshaft with stripe-like convex units on the surface is manufactured. Referring to FIG. 13, in this example, the stripe-like convex unit forms an angle of 45° with the axis of crankshaft wherein the width d₃ of each stripes is 3 mm and its height is 0.15 mm, the distance L₈ between adjacent stripes (center to center) is 10 mm. The ratio of the geometrical area of the stripe-like convex units projected on the surface of the base with respect to the whole surface area of the base is 10%. The material used is QT700-2. The hardness of the crankshaft is HB200-230. After treated, the hardness of the stripe is HB390-410. The hardness of the coupling bearing is HB150-170. Under the same working condition, comparing the original crankshaft which is treated by surface nitride hardening (the treating time is three hours and is heated under high temperature for a long time) with the crankshaft having bionic non-smooth surface as mentioned above (the treating time is one hour and four minutes), the life-span of the coupling bearing goes up by 11%. The friction coefficient between the crankshaft and the coupling bearing is reduced by 23%, and the life-span of the crankshaft with bionic non-smooth surface is 5.1 times than that with smooth surface. The treating cost of bionic non-smooth surface, compared with that of smooth surface treated by surface nitride hardening, is reduced by 14%.

### EXAMPLE 12

A crank rotation part—crankshaft with stripe-like convex units on the surface is manufactured. Referring to FIG. 13, in this example, the stripe-like convex unit forms an angle of 45° with the axis of crankshaft, wherein the width d₃ of the stripe is 1 mm and its height is 0.01 mm, the distance L₈ between adjacent stripes (center to center) is 8 mm. The ratio of the geometrical area of the stripe-like convex units projected on the surface of the base with respect to the whole surface area of the base is 11.1%. The material used is QT700-2. The hardness of the base is HB200-230. After treated, the hardness of the stripe is HB390-410. The hardness of the coupling bearing is HB150-170. Under the same working condition, comparing the crankshaft having the bionic non-smooth surface with the original crankshaft treated by surface nitride hardening, the life-span of the coupling bearing goes up by 19%. The friction coefficient between the crankshaft and the coupling bearing is reduced by 27%, and the life-span of the crankshaft with bionic non-smooth surface is 5.9 times than that with smooth surface. The treating cost of bionic non-smooth surface, comparing with that of smooth surface treated by surface nitride hardening, is reduced by 11%.

### EXAMPLE 13

A crank rotation part-crankshaft with stripe-like convex units on the surface is manufactured. Referring to FIG. 13, in this example, the stripe-like convex unit forms an angle of 45° with the axis of crankshaft, wherein the width d₃ of the stripe is 2.6 mm and its height is 2 mm, the distance L₈ between adjacent stripes (center to center) is 6 mm. The ratio of the geometrical area of the stripe-like convex units projected on the surface of the base with respect to the whole surface area of the base is 40%. The material used is Q T700-2. The hardness of the crankshaft is HB200-230. After treated, the hardness of the stripe is HB210-250. The hardness of the coupling bearing is HB150-170. Under the same working condition, comparing the crankshaft with the bionic non-smooth surface with the original crankshaft treated by surface nitride hardening, the life-span of the coupling bearing goes up by 7%. The friction coefficient between the crankshaft and the coupling bearing is reduced by 12%, and the life-span of crankshaft with bionic non-smooth surface is 4.8 times than that with smooth surface. The treating cost of bionic non-smooth surface, comparing with that of smooth surface treated by surface nitride hardening, is reduced by 4%.

### EXAMPLE 14

A crank rotation part-crankshaft with mesh-like (diamond shape) convex units on the surface is manufactured. It this configuration, the mesh-like convex unit can also be viewed as stripe unit composed by a plurality of continual spherical crowns. Referring to FIG. 12, in this example, the mesh-like convex unit forms an angle θ₃ of 45° with the axis of crankshaft, wherein the width d₂ is 0.6-1 mm and the height of the mesh is 0.1 mm, the distance L₇ between adjacent meshes (measuring from its center) is 6 mm. The ratio of the geometrical area of mesh-like convex units projected on the surface of the base and the whole surface area of the base is 10-15%. The material used is QT700-2. The hardness of the crankshaft is HB200-230. After treated, the hardness of the convex units is HB350-370. The hardness of the coupling bearing is HB150-170. Under the same working condition, comparing the crankshaft with the bionic non-smooth surface with the original crankshaft treated by surface nitride hardening, the life-span of the coupling bearing goes up by 6%. The friction coefficient between the crankshaft and the coupling bearing is reduced by 13%, and the life-span of crankshaft with bionic non-smooth surface is 6.8 times than that with smooth surface. The treating cost of bionic non-smooth surface, comparing with that of smooth surface treated by surface nitride hardening, goes up by 17%.

### EXAMPLE 15

A crank rotation part—crankshaft with mesh-like (diamond shape) convex units on the surface is manufactured. Referring to FIG. 12, in this example, the mesh-like convex unit forms an angle θ₃ of 55° with the axis of crankshaft, wherein the width d₂ is 1.5-1.8 mm and the height of each mesh is 0.1 mm, the distance L₇ between adjacent meshes (center to center) is 8 mm. The ratio of the geometrical area of convex units projected on the surface of the base with respect to the whole surface area of the base is 15-18%. The material used is QT700-2. The hardness of the crankshaft is HB200-230. After treated, the hardness of the convex units is HB300-340. The hardness of the coupling bearing is HB150-170. Under the same working condition, comparing the crankshaft with the bionic non-smooth surface with the original crankshaft treated by surface nitride hardening, the life-span of the coupling bearing goes up by 7.1%. The friction coefficient between the crankshaft and the coupling bearing is reduced by 13.7%, and the life-span of crankshaft with bionic non-smooth surface is 7.1 times than that with smooth surface. The treating cost of bionic non-smooth surface, comparing with that of smooth surface treated by surface nitride hardening, goes up by 15%.

### EXAMPLE 16

A crank rotation part—crankshaft with mesh-like (diamond shape) convex units on the surface is manufactured. Referring to FIG. 12, in this example, the mesh-like convex unit forms an angle θ₃ of 65° with the axis of crankshaft, wherein the width d₂ is 1.5-1.8 mm and the height is 0.1 mm, the distance L₇ between adjacent meshes is 10 mm. The ratio of the geometrical area of the convex units projected on the surface of the base with respect to the whole surface area of the base is 13-15%. The material used is QT700-2. The hardness of the crankshaft is HB200-230. After treated, the hardness of the convex units is HB330-350. The hardness of the coupling bearing is HB150-170. Under the same working condition, comparing the crankshaft with the bionic non-smooth surface with the original crankshaft treated by surface nitride hardening, the life-span of the coupling bearing goes up by 7.1%, the friction coefficient between the crankshaft and the coupling bearing is reduced by 13.7%, and the life-span of crankshaft with bionic non-smooth surface is 5.9 times than that with smooth surface. The treating cost of bionic non-smooth surface, comparing with that of smooth surface treated by surface nitride hardening, goes up by 9%.

3. The Application of the Invention on the Striking Board of the Coal Miller

The striking board of coal miller in the thermal power plant is a main part prone to be worn. The economical loss in it is very astonishing. According to the incomplete statistics of the related department, the economic loss that caused by abrasion and friction reach RMB 40 billions every year in China. When the striking board works, the board rotates at a high speed driven by the electric motor whose rotate speed is 985 r/min with a diameter of 1.6 m, and the linear velocity of its outer fringe could reach 82 m/s. The striking of the striking board crushes the fed coal and the striking board is just scoured and abraded in the situation. The striking board bears so heavy pushing stress under the impacting load that there are many pits, wrinkle, furrow etc. on the surface of the board, which is its main invalidity form. After the board worn, the coal output of the coal miller is reduced, and the replacing period of the striking board is shortened. The production efficiency is reduced and the production cost is increased. At present, the striking board of the coal miller is generally made of high manganese steel with fine wearability and high toughness, and the combination of casting and heat-treatment—water-tempered treatment is used to improve the wearability of its surface. The treatment could remove the carbide and get a single austenitic organization, so the material of the striking board has very high toughness. When it works under the impacting load or heavy pushing stress, its working surface will be rigidified rapidly. The hardness of the high manganese steel is generally controlled in the range of HRC54-58. The inner part of high manganese steel is still in a high toughness state, although its surface has been rigidified. If the rigidified layer is defined, the wearability is defined. With the passing of the time, the rigidified layer becomes thinner, but the rigidity value remains invariable since the effect of the hardening makes the rigidified layer become thicker. When they reach to a balance, there will be a stable abrasion. There are some other thermal power plants improving the wearability of the striking board by using piling-weld technology to create a layer of wearable alloy on its surface. Nevertheless, it is limited to improve the wearability of the striking board by studying the new wearable materials or by heat treatment on the surface of striking board.

### EXAMPLE 17

Based on the invention, the striking board having a bionic non-smooth surface with scale-like convex units is manufactured. The non-smooth surface with scale-like convex units transfers the action of scraping and gouging in the friction course between the striking board and the coal block into rolling, which greatly lessens the damage produced by the coal blocks striking on the surface of striking board. As shown in FIG. 14, in this example, the length L₉ of the longer axis of the scale-like convex unit on the surface of striking board is 40 mm, the length L₁₀ of the shorter axis is 20 mm, and the height of the scale is 2 mm. The distribution of the scale-like convex unit presents a rectangular shape. The sidelines of the rectangle and axis line of the unit form an angle θ₄ of 45°. The ratio of the geometrical area of the convex units projected on the surface of the base with respect to the whole surface area of the base is about 40%. In this way, the bionic striking board having a non-smooth surface can be obtained by the process of precision-casting or surface heat-treatment. The actually productive technology and the material of the bionic striking board are not changed, and the wearability is increased one time without any other additional productive cost.

### EXAMPLE 18

The striking board having a bionic non-smooth surface with scale-like convex units is manufactured. As shown in FIG. 14, the length L₉ of the longer axis of the scale-like convex unit on the surface of striking board is 30 mm, the length L₁₀ of the shorter axis is 15 mm, and the height of the scale is 2 mm. The distribution of the scale-like convex unit presents a rectangular shape. The sideline of the rectangle and axis line of the unit form an angle θ₄ of 45°. The ratio of the geometrical area of the convex units projected on the surface of the base with respect to the whole surface area of the base is about 30%. In this way, the bionic striking board having a non-smooth surface with scale-like convex units can be obtained by the process of precision-casting or surface heat-treatment. The actually productive technology and the material of the bionic striking board are not changed, and the wearability is increased 1.8 times without any other additional productive cost.

### EXAMPLE 19

The striking board having a bionic non-smooth surface with scale-like convex units is manufactured. As shown in FIG. 14, the length L₉ of the longer axis of the scale-like convex unit on the surface of striking board is 20 mm, the length L₁₀ of the shorter axis is 10 mm, and the height of the scale is 1 mm. The distribution of the scale-like convex unit presents a rectangular shape. The sideline of the rectangle and axis line of the unit form an angle θ₄ of 45°. The ratio of the geometrical area of the convex units projected on the surface of the base with respect to the whole surface area of the base is about 30%. In this way, the bionic striking board having a non-smooth surface with scale-like convex units can be obtained by the process of precision-casting or surface heat-treatment. The actually productive technology and the material of the bionic striking board are not changed, and the wearability is increased 1.2 times without any other additional productive cost.

### EXAMPLE 20

The striking board having a bionic non-smooth surface with spherical crown-like convex units is manufactured. As shown in FIG. 15, the diameter of the spherical crown-like convex unit on the surface of striking board is 10 mm, and its height is 2 mm. The ratio of the geometrical area of the convex units projected on the surface of the base with respect to the whole surface area of the base is about 35%. In this way, the bionic striking board having a non-smooth surface with spherical crown-like convex units can be obtained through the process of precision-casting or surface heat-treatment. The actually productive technology and the material of the bionic striking board are not changed, and the wearability is increased 1.3 times without any other additional productive cost.

### EXAMPLE 21

The striking board having a bionic non-smooth surface with spherical crown-like convex units is manufactured. As shown in FIG. 15, the diameter of the spherical crown-like convex unit on the surface of striking board is 15 mm, and its height is 2 mm. The ratio of the geometrical area of the convex units projected on the surface of the base with respect to the whole surface area of the base is about 30%. In this way, the bionic striking board having a non-smooth surface can be obtained through the process of precision-casting or surface heat-treatment. The actually productive technology and the material of the bionic striking board are not changed, and the wearability is increased 1.6 times without any other additional productive cost.

### EXAMPLE 22

The striking board having a bionic non-smooth surface with spherical crown-like convex units is manufactured. As shown in FIG. 15, the diameter of the spherical crown-like convex unit on the surface of striking board is 30 mm, and its height is 2 mm. The ratio of the geometrical area of the convex units projected on the surface of the base and the whole surface area of the base is about 25%. In this way, the bionic striking board having a non-smooth surface can be obtained through the process of precision-casting or surface heat-treatment. The actually productive technology and the material of the bionic striking board are not changed, and the wearability is increased 1.3 times without any other additional productive cost.

4. The Application of the Invention on the Pipeline Elbow to Transport the Coal Powder in Power Plant

In power plant, the operating pressure in pipeline elbow is as high as 2.2 MP, which is used to transport the coal powder. The severe scouring wear leads to a short working life and influences its working quality. Making use of bionic surface of non-smooth convex units, the inside wall surface of the elbow could be designed into the a non-smooth surface which transfers the action of scraping and gouging in the friction course between the coal powder and the surface of pipeline elbow into rolling, so as to greatly reduce the cohesive abrasion, the relative friction coefficient and the local resistance of the elbow. Therefore, its ability of enduring the scouring wear and the operating life are enhanced.

### EXAMPLE 23

The pipeline elbow having a bionic non-smooth surface with spherical crown-like convex units is manufactured. As shown in FIG. 15, the spherical crown-like convex units are arrayed in the shape of diamond. The diameter of the spherical crown is 20 mm, and its height is 2 mm. The ratio of the geometrical area of the spherical crown-like convex units projected on the surface of the base with respect to the whole surface area of the base is 35%. In this way, the bionic pipeline elbow having a non-smooth surface with spherical crown-like convex units distributed in a diamond shape can be obtained through the process of precision-casting or surface heat-treatment. The actually productive technology and the material of the bionic pipeline elbow are not changed, and the wearability is increased 1.5 times without any other additional productive cost.

### EXAMPLE 24

The pipeline elbow with a bionic non-smooth surface with spherical crown-like convex units is manufactured. As shown in FIG. 15, the spherical crown-like convex units are arrayed in the shape of diamond. The diameter of the spherical crown is 20 mm, and its height is 2 mm. The ratio of the geometrical area of the convex units projected on the surface of the base with respect to the whole surface area of the base is about 10%. In this way, the bionic pipeline elbow with a non-smooth surface of spherical crown-like convex units distributed in diamond shape can be obtained through the process of precision-casting or surface heat-treatment. The actually productive technology and the material of the bionic pipeline elbow are not changed, and the wearability is increased 1.4 times without any other additional productive cost.

### EXAMPLE 25

The pipeline elbow having a bionic non-smooth surface with spherical crown-like convex units is manufactured. As shown in FIG. 15, the spherical crown-like convex units are arrayed in the shape of diamond, the diameter of spherical crown-like convex unit is 15 mm, and its height is 2 mm. The ratio of the geometrical area of the spherical crown-like convex units projected on the surface of the base with respect to the whole surface area of the base is 40%. In this way, the bionic pipeline elbow having a non-smooth surface with spherical crown-like convex units distributed in diamond shape can be obtained through the process of precision-casting or surface heat-treatment. The actually productive technology and the material of the bionic pipeline elbow are not changed, and the wearability is increased 1.9 times without any other additional productive cost.

Thus it can be seen, the essence of the invention is to break through the traditional idea in the prior art-the smoother the surface is, the better the wear resistance performance of the material is, and to improve the wear resistance performance by forming a bionic non-smooth surface. Based on the working condition and requisition on wear resistance performance of the mechanical component, various kinds of bionic convex forms could be chosen to design various surface distributed configuration. Obviously, the embodiments and examples on some specific applications as described above are only given for the explanation of the invention, and it does not intend to limit the scope of the invention. In other words, the various forms of the non-smooth units are too numerous to mention each of them here, so the examples mentioned above can't be understood to the only limited forms of the invention. In fact, one skilled in the art can make various kinds of change or reformation based on the principle of the invention. For example, though the examples as mentioned above mainly deal with metal parts, it is obviously that the invention can be used to nonmetallic materials such as ceramic material, etc. Besides, the convex unit can be replaced by concave unit, and different unit, different density in different areas of the same surface or the combination thereof can be selected. All these changes or modification will fall within the spirit and scope of the invention.

1. A method of improving the wear resistance performance of a mechanical component, comprising: making the frictional surface of the mechanical component be a bionic non-smooth surface, wherein a plurality of convex units are distributed on the surface of the base of the mechanical component, the altitude difference between the convex units and the base is 0.01-2 mm, the distributed density (S) of the units, i.e., the ratio of the geometrical area of the convex units projected on the surface of the base with respect to the whole surface area of the base, is 10-40%, and the hardness difference between the convex units and the base is HB0-200.

2. A method of improving the wear resistance performance of mechanical component according to claim 1, wherein the convex units are shaped like spherical crown, scale, mesh or stripe.

3. A method of improving the wear resistance performance of mechanical component according to claim 2, wherein the spherical crown-like convex units are distributed as a matrix in the following mode: the diameter of the base circle of the crown is 1-3 mm, the height of the crown is 0.1 mm, and the distributed density (S) of the convex units is 12-18%.

4. A method of improving the wear resistance performance of mechanical component according to claim 2, wherein the spherical crown-like convex units are distributed as diamond in the following mode: the diameter of the base circle of the crown is 10-30 mm, the height of the crown is 2 mm.

5. A method of improving the wear resistance performance of mechanical component according to claim 2, wherein the mesh-like convex units are distributed as square in the following mode: the width of the mesh is 1.5-2 mm, the distance between adjacent meshes is 6-10 mm, and the height of the mesh is 0.01-0.15 mm.

6. A method of improving the wear resistance performance of mechanical component according to claim 2, wherein the mesh-like convex units are distributed as diamond in the following mode: the width of the mesh is 1.5-2.0 mm, the distance between adjacent meshes is 6-10 mm, the smaller angle between the adjacent meshes is 40, and the height of the mesh is 0.01-0.15 mm.

7. A method of improving the wear resistance performance of mechanical component according to claim 2, wherein the stripe-like convex units are distributed in the following mode: the width of the stripe is 1-3 mm, the distance between the adjacent stripes is 6-10 mm, and the height of the stripe is 0.01-2.0 mm.

8. A method of improving the wear resistance performance of mechanical component according to claim 2, wherein the scale-like convex units are distributed in the following mode: the length of the longer axis of the scale is 20-40 mm, the length of the shorter axis of the scale is 10-20 mm, the height of the scale is 0.5-2.0 mm.
